(19) United States
(12) Patent Application Publication
(10) Pub. No.: US 2006/0236490 A1
(43) Pub. Date: Oct. 26, 2006

(54) Onboard vacuum cleaner system for mobile vehicle

(76) Inventors: Derek Blitz, Portland, OR (US); Nathan Denver, Sewickley, PA (US); Lawrence Hsieh, San Diego, CA (US); Charles Goldenberg, Yorktown Heights, NY (US); Jenny Lynn Cargiuolo, Bedford, MA (US)

Correspondence Address: INTERNATIONAL TRUCK INTELLECTUAL PROPERTY COMPANY,, 4201 WINFIELD ROAD, P.O. BOX 1488, WARRENVILLE, IL, 60555, US

(21) Appl. No.: 11/399,088

(22) Filed: Apr. 6, 2006

Related U.S. Application Data
(60) Provisional application No. 60/669,634, filed on Apr. 7, 2005.

(51) Int. Cl. B60S 1/54

(52) U.S. Cl. 15/313

(57) ABSTRACT

An onboard vacuum system for a mobile vehicle. The onboard vacuum system includes a vacuum cleaner unit stored in a non-visible location in a motor vehicle sleeper compartment. The vacuum cleaner unit includes a motor and filter as well as a refuse container. The hose from the vacuum cleaner is wound onto a hose reel that may have a retractor. The hose and nozzle from the hose reel or coil protrude within the sleeper compartment. In one version, the hose and nozzle protrude and may be withdrawn from a storage cabinet for clothing allowing access to the entire sleeper floor and bunks for vacuuming operations.

This patent issues from a non-provisional patent application claiming the priority of provisional patent applications Ser. Nos. 60/669,634, filed Apr. 7, 2005.

### BACKGROUND

Trucks carry a bulk of the goods within the United States. Driver's have a difficult lifestyle in which they spend much of their time within the cab and sleeper of their over the road tractor trailers. They must comply with federal regulations in the United States that limit the amount of time behind the wheel. The truck becomes their home away from home. The need to relax when the vehicle is not being driven sometimes results in the environment not being the cleanest one available. One of the problems is that dirt accumulates and it becomes an extra chore to obtain a stand alone vacuum to plug in, operate and clean the sleeper and bunks, and then store the vacuum subsequently. Drivers do not have the time and as a result truck sleepers can become unpleasant places for the drivers. The inventors spent some time researching truckers. After conducting several research interviews, three distinct classes of truckers emerged: Spotless, Average and Filthy.

From research done with truck drivers and a truck dealership, about 2 out of 10 truck drivers fall into the “spotless” class. As the name suggests, these drivers strive tirelessly to keep their cab and truck in a “spotless” state. It is not uncommon to find them cleaning their trucks regularly every night. Additionally, this class will spend the funds in order to maintain their level of cleanliness, favoring high-end cleaning products. For them, being clean is a source of pride and prestige.

To properly appeal to this “spotless” group, the final product must above all perform well. This group greatly values dependability and performance. Additionally, the final product must also be more convenient and effortless compared to their current solutions.

About 5 out of 10 truck drivers compose the “average” category. In this category, truck drivers perform normal maintenance and cleaning on a regular basis. This is typically cleaning every 1 to 2 weeks and a major cleaning once every couple months. They use normal household products, often just “borrowing” cleaning supplies from home on to the road. For this group, cleaning is required in order to maintain a workable environment to live in.

To reach this “average” group, the product must be convenient and simple to use. Cleaning is a secondary concern, so these drivers will not spend the time necessary to learn or deal with a complicated solution. This group is also concerned with time, so in addition to convenience, quickness is an important attribute. If the solution can minimize cleaning time, this frees up valuable time for the truckers to spend on other tasks.

The remaining group is the “filthy” class, making up 3 out of 10 drivers. As the name suggests, this group opts for a very “lived in” environment, not paying too much attention of maintaining any level of cleanliness inside the cab. For these drivers, getting from point A to point B is the biggest concern. As long as there is room on the bed (after pushing some mess around), they are happy. Usually an external force is needed for these drivers to clean—inspection, selling, and visitors.

This “filthy” group presents the greatest challenge to reach since cleaning is the last thing on their mind. Convenience of the product will need to be emphasized, using the message, “If it's there and it's easy—then why not clean?” Additionally, educating this class of the value of cleaning for inspection, resale value, and health will equally be important.

### SUMMARY

This invention relates to an onboard vacuum system for a mobile vehicle. The onboard vacuum system includes a vacuum cleaner unit stored in a non-visible location in a motor vehicle sleeper compartment. The vacuum cleaner unit includes a motor and filter as well as a refuse container. The hose from the vacuum cleaner is wound onto a hose reel that may have a retractor. The hose and nozzle from the hose reel or coil protrude within the sleeper compartment. In one version, the hose and nozzle protrude and may be withdrawn from a storage cabinet for clothing allowing access to the entire sleeper floor and bunks for vacuuming operations.

### DRAWINGS

Other objects and advantages of the invention will become more apparent upon perusal of the detailed description thereof and upon inspection of the drawings, in which:

FIG. 1 is a side view of a mobile vehicle with an onboard vacuum system made in accordance with the invention installed.

FIG. 2 is a perspective of the sleeper compartment of the mobile vehicle of FIG. 1 showing the hose and nozzle of the onboard vacuum system.

FIG. 3 is a top down view of the vacuum cleaner system of FIGS. 1 and 2.

### DESCRIPTION OF INVENTION

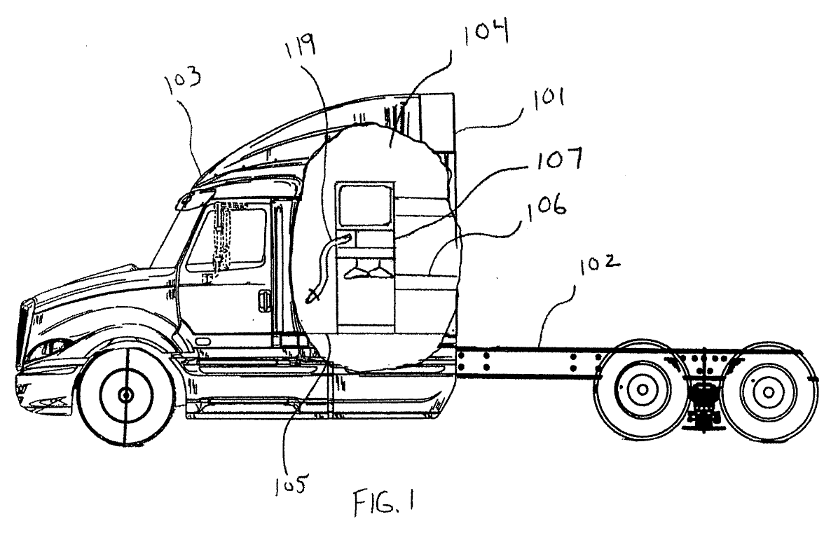

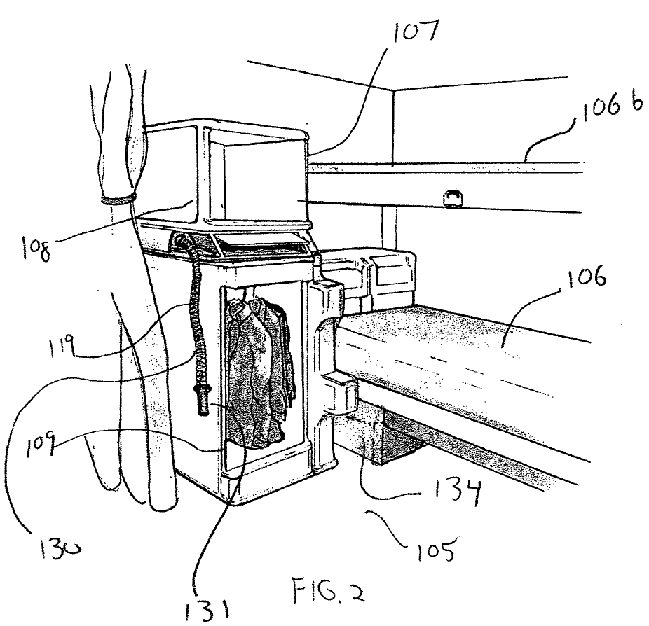

A motor vehicle 101, specifically a tractor trailer, includes a cab 103 engaged to a drive train bearing chassis 102. For over the road tractors, there will be a sleeper compartment 104 that includes a driver living space. The sleeper compartment 104 includes a mounting floor 105 as well as the off duty living space for the driver or drivers. The vehicle 101 shown in FIG. 1 has an onboard vacuum cleaner system 119 made in accordance with the invention mounted within the sleeper compartment 104. There are sleeping bunks 106 and 106b in the rearward portion of the sleeper compartment 104. Just forward of the sleeping bunks 106 and 106b is a storage cabinet 107 installed on the mounting floor 105. The storage cabinet 107 is for clothing and driver equipment. The storage cabinet 107 may include a space for hanging clothing credenza 109 and upper storage area 108 as better shown in FIG. 2.

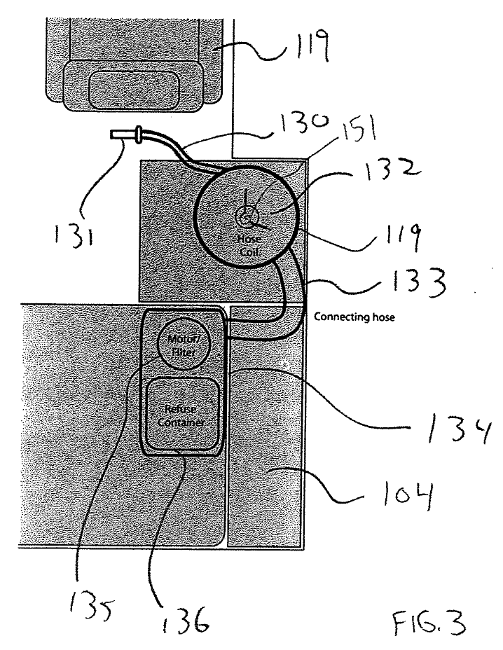

The onboard vacuum cleaner system 119 has a hose 130 and nozzle 131. The hose 130 may be run through the storage cabinet 106 to provide easy access to the entire sleeper compartment 104 for vacuuming. The hose 130 of the vacuum cleaner system 119 may be run from different locations so long as the hose can reach the entire mounting floor 105 and the bunks 106 and 106b. The vacuum hose 130 is wound or loaded onto a hose coil or reel 132 as shown in FIG. 3. The hose reel 132 may include a winding mechanism 151 such as a torsional spring 151 for example. The winding mechanism 151 provides tension or energy tending to cause the hose 130 to rewind onto the hose coil 132 when the hose 130 is withdrawn from the hose coil 132. The hose 130 on the hose coil is engaged to a suction hose 133 which is further engaged to a vacuum unit 134. The vacuum cleaner unit 134 may be stored below the bunk 106 or below the mounting floor 105. The vacuum cleaner unit 134 has an electric motor and filter 135 as well as a refuse container 136. During operation, the driver retracts the hose 130 and nozzle 131 from the opening in the storage cabinet 107. The hose 130 under tension from the winding mechanism 151 unrollls from the hose coil 132 that is out of site of the driver. The driver energizes the vacuum motor 135 using a remote switch in the sleeper compartment 104. He vacuums using the nozzle 131. The vacuum motor 135 sucks dirt through the nozzle 131, the hose 130, the suction hose 133 and deposits the dirt and debris from the sleeper 104 into the refuse container 136. The refuse container 136 may be emptied when it is full.

An easy-to-use, integrated vacuum system 119 has been chosen as the concept direction to address the need of truck drivers and fleet owners for a convenient way to clean the cab and prevent the build up of dirt and grime. This decision was decided after much work and deliberation. Intercept interviews with truckers revealed a significant interest among truck drivers in the cleanliness of the cab and that the drivers would utilize an integrated vacuum if such a system were pre-installed in their trucks. The inventor team had been looking for a method to effectively clean the trucker's living space. After further research, the team confirmed that a “quick cleaning” solution would most likely lead to a successful product. Thus, with these points in mind, the group realized that an opportunity exists in providing truckers with an easy-to-use, integrated vacuum system for quick cleaning tasks.

The team's direction is an integrated vacuum system for quick cleaning tasks. This vacuum system should be so easy to access that a trucker would actually choose to grab the vacuum to clean up three dropped peanut shells instead of bending over and picking them up by hand. The vacuum will be integrated into the truck to add perceived value to the truck itself. The team has chosen this direction because of the design's promise in terms of prevention, boosting brand image, optimizing the cleaning experience for the trucker, and providing the trucker with a measure of convenience and independence.

By making cleaning up as easy as possible, the quick vac will encourage the use of cleaning as a preventive measure. The dirt from spilled food and tracked in salt and sand will never have a chance to get ground into the floor if the mess is cleaned up as it appears in the truck. This measure of prevention may keep the truck from becoming a dirty and abused environment, which should positively affect the resale value of the vehicle 101.

By integrating the vacuum system into the truck, the team hopes to add more perceived value to the truck. Adding a product to the truck that will allow the trucker to live more easily should add more perceived value than just the cost of the vacuum system 119.

By making the vacuum easily accessible and specifically designed for the usage it will receive in the truck, the team hopes that the product will greatly reduce the amount of effort and annoyance involved in the trucker's cleaning experience. This easy accessibility includes a retractable hose to prevent the trucker from having to uncoil and recoil the vacuum in the truck where stowing equipment so that it won't be in the way is already a large hassle.

The truckers currently either vacuum on the occasions that they return home or to their main plant, with an underpowered dust buster on the road, or when they are in line at a truck wash. By giving the trucker a portable vacuum cleaner that works well, a truck manufacturer will be providing the trucker with a way to clean their home at their leisure. The truckers can clean their trucks while waiting to be loaded or unloaded, while at a rest stop, or idling on the side of the road.

The integrated quick vac concept is a challenging one. In order to integrate an easily accessible (for taking out and putting away) vacuum hose, the team needed to innovate within the field of vacuuming to create a retractable vacuum hose. In order to do this, the team has looked at other fields for ideas such as the single wrap coils of pneumatic hose and the Macintosh power cables that wrap into their own little box though the use of a central spring. The team also looked at the worm gears that are used to thread coils of fishing line. The team believes that a single wrap of hose will be simpler, with fewer breakable components. This single wrap of hose will wrap around a hub of about 6″ and will in a preferred embodiment have a final diameter between 15″ and 17″ with a width of 2″ to 4″ depending on the diameter of the vacuum hose. A standard 1¼″ hose diameter is being considered as compared to a smaller 1″ outer hose diameter. The location of the hose storage system may change as the team increases its understanding of the structure of the truck underneath the floor. A standard 1¼′ hose would be preferable for repair and the purchase of standard vacuum attachments. However, the team has found three areas of the truck that will fit the 15″ diameter wrap of a 1¼″ hose in the interior of the truck that should not significantly cut down on usable storage space.

The handle of the vacuum is the part that the trucker will be grabbing to pull out the retractable hose. It is also the part of the vacuum that will be on the interior of the living space. The handle may be exposed to the living space or covered by a swinging or sliding panel. The handle may be a telescoping stick attachment so that the trucker can vacuum the floor without bending down but be able to telescope the stick shorter to make it more maneuverable within the small space of the truck cab.

The placement of the end of the vacuum is partially determined by the placement of the retractable hose. The team believes that wherever the coiled vacuum hose is, the trucker will need to pull the hose out at an angle tangent to the wrapped coil. The team believes that snaking the handle into another area of the truck away from the coil would demand a system of pulleys that would add resistance and make the hose harder to pull out, as well adding unnecessary breakable mechanical parts.

The other factor determining the placement of the handle of the retractable hose is the ergonomic analysis that the team did of the truck.

The team wants to provide a versatile vacuuming system for truckers that want to occasionally spend more time cleaning the truck. In order to do this, the team will design several vacuum attachments. The team has discussed many vacuum attachments but the frontrunners are: an attachment with a nozzle resembling keyboard vacuums to reach into small nooks and crannies in the truck, a general wide vacuum attachment for large spaces, a rotating brush attachment for carpeting, possibly a vacuum attachment that is malleable that conforms to an area creating better suction, a flexible attachment that can bend, and a soft, padded vacuum attachment to be used on glass, the dashboard, and leather upholstery.

As described above, the onboard vacuum system of this invention and vehicle made with the onboard vacuum system provide a number of advantages, some of which have been described above and others of which are inherent in the invention. Also modifications may be proposed to the onboard vacuum system of this invention and vehicle made with the onboard vacuum system without departing from the teachings herein.

We claim:

1. A mobile vehicle in combination with an onboard vacuum system, comprising:
a cab engaged to a drive train bearing chassis;
a sleeper compartment including a driver living space;
an onboard vacuum cleaner system mounted within said sleeper compartment;
said onboard vacuum cleaner system having a hose and nozzle;
said hose being wound onto a hose coil;
said hose reel including a winding mechanism;
said winding providing energy tending to cause said hose to rewind onto said hose coil when said hose is withdrawn from said hose coil for vacuuming;
said hose on said hose coil being engaged to a suction hose which which is further engaged to a vacuum unit;
said vacuum cleaner unit being stored in an area outside of the visible interior of said sleeper compartment; and
said vacuum cleaner unit having an electric motor and filter as well as a refuse container.

2. The mobile vehicle of claim 1, wherein:
a storage cabinet being engaged to a mounting floor of said sleeper compartment; and
said hose being run through said storage cabinet to provide access to said sleeper compartment for vacuuming.

3. The mobile vehicle of claim 1, wherein:
said winding mechanism including a torsional spring to provide tension to retract said hose onto said hose coil.

4. The mobile vehicle of claim 1, wherein:
said vacuum cleaner unit being stored under a bunk in said sleeper compartment.

5. The mobile vehicle of claim 1, wherein:
said vacuum cleaner unit being stored under a mounting floor in said sleeper compartment.

6. The mobile vehicle of claim 2, wherein:
said winding mechanism including a torsional spring to provide tension to retract said hose onto said hose coil.

7. The mobile vehicle of claim 6, wherein:
said vacuum cleaner unit being stored under a bunk in said sleeper compartment.

8. The mobile vehicle of claim 6, wherein:
said vacuum cleaner unit being stored under a mounting floor in said sleeper compartment.
